(19) United States
(12) Patent Application Publication
(10) Pub. No.: US 2010/0217603 A1
(43) Pub. Date: Aug. 26, 2010

(54) Method, System, and Apparatus for Enabling Adaptive Natural Language Processing

(76) Inventors: Daniel D. Hammond, Dallas, TX (US); Myra A. Hambleton, Plano, TX (US)

Correspondence Address: BAKER BOTTS L.L.P., 2001 ROSS AVENUE, SUITE 600, DALLAS, TX, 75201-2980, US

(21) Appl. No.: 12/393,425

(22) Filed: Feb. 26, 2009

(51) Int. Cl. G10L 11/00; G06F 17/30

(52) U.S. Cl. 704/270.1; 704/E11.001; 707/E17.01

(57) ABSTRACT

An adaptive processing system includes one or more adaptive processing engines that are adapted to receive the one or more requests. The one or more adaptive processing engines adapted to parse the one or more requests and to communicate one or more queries to the one or more communication devices based at least in part on the information of the request. In one embodiment, the parsing of the one or more queries includes analyzing the information from the user, determining one or more next steps to perform based at least in part on the information from the user, and generating one or more queries for additional information. The system also includes an application server adapted to communicate with the one or more adaptive processing engines in response to the one or more requests based at least in part on the information of the one or more requests.

### TECHNICAL FIELD

This disclosure relates in general to the field of communication systems, and more particularly to a method, system, and apparatus that provides adaptive natural language processing.

### OVERVIEW

Communication systems often operate to collect information from and/or provide information to one or more users of the communication system. The communication systems typically employ one or more programs that control the collection and/or the presentation of information to a user through one or more pre-determined or pre-defined processes. Conventional communication systems may, in some cases, require interaction with a remote input/output device to collect information from the user during the information collection process. For example, the input/output device may provide a communication path between the user of the device and a voice processing system (VPS). The VPS may include programs that respond to audio input, such as dual-tone multi-frequency (DTMF) or voice, and produce audio output back through the network to the user. The VPS may also use a predetermined script to guide the users interaction during the information collection process.

### SUMMARY OF EXAMPLE EMBODIMENTS

In accordance with one embodiment of the present disclosure, an adaptive processing system comprises one or more communication devices that are adapted to communicate one or more requests for processing. In one embodiment, each of the one or more requests comprises information from a user. The system further comprises one or more adaptive processing engines that are adapted to receive the one or more requests. The one or more adaptive processing engines adapted to parse the one or more requests and to communicate one or more queries to the one or more communication devices based at least in part on the information of the request. In one embodiment, the parsing of the one or more queries comprises analyzing the information from the user, determining one or more next steps to perform based at least in part on the information from the user, and generating one or more queries for additional information. The system also comprises an application server adapted to communicate with the one or more adaptive processing engines in response to the one or more requests based at least in part on the information of the one or more requests.

In accordance with another embodiment of the present disclosure, a method for processing a transaction comprises receiving one or more requests for processing at an adaptive processing engine. Each of the one or more requests comprises one or more data elements from a user. The method also comprises analyzing the one or more data elements from the user. The method further comprises determining one or more next steps to perform based at least in part on the one or more data elements from the user. The method also comprises generating one or more queries for additional information based at least in part on the one or more data elements of the request.

Numerous technical advantages are provided according to various embodiments of the present disclosure. Particular embodiments of the disclosure may exhibit none, some, or all of the following advantages depending on the implementation. For example, various embodiments may be capable of interacting with a user without using a menu-driven directed application. Other embodiments may be capable of interpreting natural language input from a user and adapting additional queries of information to the user based at least in part on the information provided by the user. The additional generated queries or statements are based on system derived knowledge for what the user is trying to achieve by communicating with the system. Certain other embodiments may be capable of responding to a user with natural language responses and prompts for information. Certain embodiments of the present disclosure may provide improvements for voice processing applications, including cost, performance, and availability.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example embodiment of a communication system capable of adaptively processing natural language queries from one or more users;

FIG. 2 illustrates one example of an adaptive natural language transaction processing system;

FIG. 3 is a flowchart illustrating an example method of using an adaptive natural language query; and

FIG. 4 is a flowchart illustrating another example method of using an adaptive natural language query.

### DETAILED DESCRIPTION

Particular examples and dimensions specified throughout this document are intended for exemplary purposes only, and are not intended to limit the scope of the present disclosure. In particular, this document is not intended to be limited to natural language processing utilized in interactive response applications.

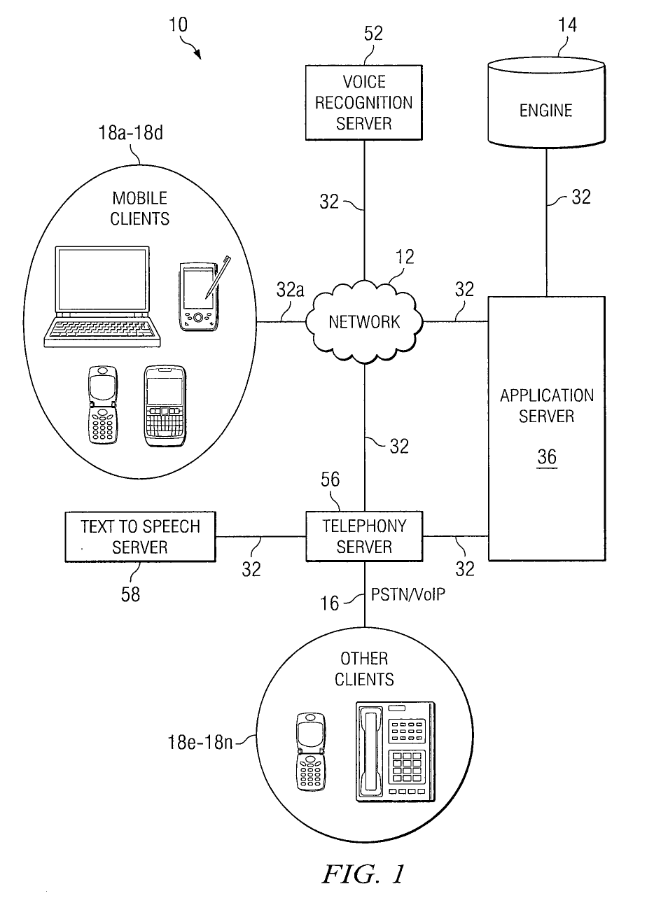

FIGS. 1 is a system diagram of an example embodiment of a communications system 10 capable of processing queries from one or more users of system 10. In various embodiments system 10 can comprise a network or communication system used by an entity, such as, for example, a hospital, a bank, or other business or non-business entity. It should be appreciated that other embodiments and uses of system 10 may be used without departing from the scope of the present disclosure.

In these examples, system 10 comprises one or more adaptive processing engines 14 operable to provide adaptive natural language driven transaction processing. Natural language is language that is written or spoken in phonemic-alphabetic form by humans for general-purpose communication, as distinguished from formal languages such as computer programming languages. Adaptive processing engines 14 may comprise any suitable combination of hardware and/or software operable to receive natural language queries from one or more clients 18a-18n and process those queries to complete one or more transactions. Adaptive processing engines 14 are further operable to request additional information from the users of the one or more clients 18a-18n with a non-menu-driven or pre-defined request, based at least in part on information provided by a user.

Adaptive processing engines 14 are capable of receiving natural language input from one or more clients 18 in various forms and use that input to determine one or more transactions that the client desires to perform. Adaptive processing engines 14 can implement an adaptive natural language system that does not implement a pre-defined or pre-determined call flow when interacting with a client 18 of system 10. Instead, engines 14 are capable of analyzing the information received from the client 18 and determining one or more next steps to perform. This advantageously permits adaptive processing engines 14 to skip steps or queries for information if engines 14 determine the steps or queries are not necessary based on, for example, the information provided to engine 14 by a user. Adaptive processing engines 14 can adapt to input provided by a user and/or other input in system 10.

Once one of the adaptive processing engines 14 determines the type of transaction desired by the client 18, engine 14 can request that the client provide one or more data elements for use in completing the transaction. Adaptive processing engines 14 can interact with the client 18 until it has all the desired data elements to perform the transaction. Adaptive processing engines 14 can gather the data elements using any appropriate number of queries, and using any appropriate type of query. Adaptive processing engines 14 can also receive information in any suitable format. Adaptive processing engines 14 can then process the data received and determine multiple communicative steps with the user and/or data processing system to complete the transaction. Adaptive processing engines 14 are also capable of sending output data in one or more forms, such as text, graphics, formatted files or voice, to the client as a result of the transaction. Adaptive processing engines 14 may also send output data to one or more other locations as requested by the client or by application server 36.

In these examples, one or more adaptive processing engines 14 communicate with one or more clients 18a-18n through network 12 and/or public switched telephone network (PSTN) 16. Network 12 may comprise any wireless network, wireline network, or combination of wireless and wireline networks capable of supporting communication between network elements using ground-based and/or space-based components. In this particular embodiment, network 12 comprises at least a portion of the global computer network known as the Internet. In other embodiments, network 12 may comprise an information network, a PSTN, an integrated services digital network (ISDN), a local area network (LAN), a wide area network (WAN), a metropolitan area network (MAN), and/or other communication systems or combination of communication systems at one or more locations.

PSTN 16 can comprise one or more public circuit-switched telephone networks. PSTN 16 can comprise a digital system, an analog system, a wireless system, or any combination thereof. In certain embodiments, PSTN 16 may be replaced with a Voice over Internet Protocol (VOIP) system or any other communication system or combination of communication systems.

One or more clients 18a-18n may couple to network 12 and/or PSTN 16 through one or more communications links 32. As used throughout this document, the term “couple” and/or “coupled” refers to any direct or indirect communication between two or more elements, whether or not those elements are in physical contact with one another. Components of system 10 may couple to one another or to network 12 and/or PSTN 16 through communication links 32. These links 32 may be used to transmit data, voice, or any other type of communication from one component to another in system 10. In other embodiments of system 10, communication links may be used to connect components not connected in this embodiment.

Communications links 32 may comprise any hardware, software, firmware, or combination thereof. In various embodiments, communications links 32 may comprise communications media capable of assisting in the communication of analog and/or digital signals. Communications links 32 may, for example, comprise a fiber optic line, a Digital Subscriber Line (DSL), a wireless link, a USB bus, a PCI bus, an ethernet interface, or any other suitable interface and/or medium operable to assist in the communication of information to and/or from network 12. In this particular embodiment, communication links 32 comprise voice or data connections. In this example, any data communicated between engine 14 and clients 18 over communication links 32 is advantageously communicated asynchronously. Communicating the data asynchronously allows more than one user to connect to engine 14 at the same time over a single data connection.

Each client 18 may comprise any computing and/or communication device capable of enabling the communication of information to and/or from network 12 or another component in system 10. In some embodiments, clients 18a-18n may enable a user of system 10 to communicate information to and/or receive information from one or more application servers 36. In other embodiments, clients 18a-18n can enable a user of system 10 to communicate information to and/or receive information from one or more components of system 10.

Client 18a-18n may comprise, for example, a wireless device, a voice over IP device, a desktop computer, a laptop computer, a personal digital assistant, a cell-phone, a telephone, a Wi-Fi device, a workstation, a mainframe computer, a mini-frame computer, a web server, or any other computing and/or communicating device.

In this particular embodiment, system 10 comprises an application server 36 operable to run applications and/or process transactions. In some cases, application server 36 may be capable of sending and/or retrieving information in response to a query from engine 14. Application server 36 may also serve as an interface to one or more other data servers.

In other embodiments, application server 36 and engine 14 may be located within the same hardware or software module, and may, in certain embodiments, share processors, memory, or other components. In some embodiments, application server 36 may comprise one or more databases, or may interface with one or more databases or database systems. Application server 36 may, for example, store information about one or more accounts corresponding to one or more users of clients 18. Clients 18 in system 10 can access the information in these accounts via engine 14. Further, clients 18 may, in certain circumstances, enter information into application server 36 or perform a transaction involving the information in application server 36.

As one example, application server 36 may comprise a database of banking account records, and a user of system 10 may wish to transfer money between two accounts. As another example, application server 36 may comprise a travel reservation system, and a user may use system 10 to make an airline reservation. In yet another example, application server 36 may comprise a brokerage system that a user can use to buy and/or sell financial instruments.

System 10 further comprises a voice recognition server 52 that is capable of interpreting spoken words by a user of client 18. In this example, voice recognition server 52 is operable to convert speech input by one or more users into a form readable by engine 14 or another component of system 10. Voice recognition server 52 may comprise any suitable combination of hardware or software to provide speech processing services to system 10. In FIG. 1, voice recognition server 52 is shown as a separate component. In certain other embodiments, voice recognition server 52 may reside wholly or in part within one or more components, such as within client 18 and/or engine 14.

In this example, system 10 further comprises a telephony server 56. A telephony server 56 is operable to provide an interface between the caller and the different components of system 10. In some embodiments, a telephony server 56 can run software that processes information or requests to/from callers and components in one or more formats. For example, the telephony server 56 may accept speech input from a user for further processing and it may return phonetic speech phrases as a reply.

System 10 may also comprise a text to speech server 58. Text to speech server 58 is operable to convert information in text format (or another non-audio speech format) to audio speech that can be sent to a user of system 10. As an example, engine 14 may provide instructions to text to speech server 58 to send one or more audio prompts or responses to a user utilizing a phone and connecting to engine 14 through PSTN 16 or network 12. Text to speech server 58 may be located in a variety of locations in system 10. For example, text to speech server 58 may be coupled to telephony server 56, as shown in FIG. 1. In another embodiment, text to speech server 58 may be coupled to engine 14.

System 10 may also comprise one or more databases (not shown). These databases may comprise any hardware, software, firmware, or combination thereof operable to store and facilitate retrieval of information. The one or more databases may store information using any of a variety of information structures, arrangements, and/or compilations. The one or more databases may, for example, comprise a dynamic random access memory (DRAM), a static random access memory (SRAM), a NAND flash memory, or any other suitable volatile or nonvolatile storage and retrieval device or combination of devices. The one or more databases may comprise any number of storage media without departing from the scope of the present disclosure. Additionally, all or part of the one or more databases could reside locally within engine 14 or application server 36 or could reside in a location remote from and accessible to engine 14. Adaptive processing engines 14 could communicate with the one or more databases through network 12 or, in other embodiments, engine 14 could communicate with the one or more databases using direct links. In certain embodiments, application server 36 could also communicate with the one or more databases using a direct link or through network 12.

In various embodiments some of the components in system 10 may be combined with another component or components or may be removed from the system. Some functions performed by one component in system 10 may be performed by multiple components in other embodiments. For example, in some embodiments, one or more of adaptive processing engine 14, voice recognition server 52, voice XML telephony server 56, text to speech server 58, and/or application server 36 can each reside on a single machine.

In some embodiments, clients 18 can be configured to initiate a connection with one or more of adaptive processing engines 14. In some cases, clients 18 can initiate a data connection with engine 14. For example, if client 18 is a mobile phone, a wireless connection can be processed through network 12 to engine 14. After the client 18 connects to engine 14, engine 14 can initiate a preliminary communication session with the user of client 18. Through this initial communication session, information regarding the target address of client 18 can be established. Address information can be gathered automatically, for example by reading a unique identification number of the device or by question and answer sequences with the user of client 18. Adaptive processing engines 14 and/or a database can also store caller associated data, such as an IP address used to establish a data connection. In some cases, engine 14 can establish a data socket connection to communicate with client 18. This connection can then be used for the duration of the communication session.

Landline phones and/or IP phones can also communicate with engine 14 in the same manner as mobile phones described above. Also, engine 14 may also use simultaneous or duplexed data connections with clients 18. This can allow engine 14 to simultaneously execute the initial communication session while also communicating over another data connection with client 18.

In one example embodiment of system 10, a user of client 18a initiates an information collection and/or transaction process by communicating a request to engine 14. For example, a user may wish to use a cell-phone to transfer money from a savings account at a bank to a checking account at the same bank. The user can call the bank's interactive voice response system, which has been configured as in system 10. System 10, in this example, comprises voice recognition technology, so the user can speak to the system to conduct the transaction. In other embodiments, the user may use a combination of spoken commands and questions and text input. In certain other embodiments, the user may conduct the entire transaction with text inputs (for example, if the user is conducting the transaction by typing with a personal computer). System 10 uses an adaptive natural language processing engine 14 in this embodiment, which operates in such a manner that a directed or pre-defined call flow is not necessary to retrieve the information from the user.

The user's cell phone connects to network 12 through connection 32a. Connection 32a, in this example, is a wireless connection to a cellular network. Network 12 completes the phone call to the interactive voice response system by connecting to engine 14 through one or more connections 32. Adaptive processing engines 14 can begin by greeting the user with a verbal greeting, such as “Welcome to ABC Bank, how may I help you?” The user can then reply verbally with one or more transaction requests.

When the user replies with a verbal transaction request, there may be at least three steps to processing the request. System 10 can first determine the actual words spoken by the user. The second step involves understanding what those words mean. The third step is determining a course of action based at least in part on the meaning of what was said. To determine the actual words spoken by the user, system 10 may use a speech recognizer. Adaptive processing engines 14 may contain a speech recognizer internally, or any spoken responses received by engine 14 may be sent to an external speech recognizer for processing, such as, for example, voice recognition server 52. The speech recognizer converts the spoken words from the user into a form usable by engine 14. The speech recognizer may, for example, convert the spoken words into text and pass those to engine 14. Adaptive processing engines 14 can then process the speech to understand that request and prepare a response and/or query to the user.

Adaptive processing engines 14 can process the user response in a variety of ways. For example, engine 14 could pick key words and/or phrases out of the user response and use those to determine a category of operation for system 10. The user may reply to the initial greeting by saying, “I'd like to transfer $500 from my savings account to my checking account.” Once the speech recognizer has converted the spoken words into a usable form, engine 14 can identify the key words in that sentence. In this example, adaptive processing engine 14 is a natural language interpreter. In some case, engine 14 can be programmed to be industry-specific so that it can interpret what the user is saying and create an appropriate action or response. Adaptive processing engines 14 may have one or more rules for certain types of categories of transactions related to banking. Adaptive processing engines 14 may have different rules or methods if used for different types of transactions. In this case, by analyzing the user's request, engine 14 can determine that the user wants to transfer money from one account to another.

To facilitate a transfer of money from one account to another, engine 14 may query for a specific set of data elements so that it can transfer the appropriate amount to the appropriate account. As one example, to transfer money, engine 14 may query for the amount to transfer, the source account, and the destination account. Since this is a financial transaction, engine 14 may also authenticate the user.

Adaptive processing engines 14 may also couple to application server 36 one or more times throughout the call process to retrieve from or send information to application server 36 Application server 36 could contain the banking records that the user is attempting to access. Or the banking records could be located in one or more databases or database systems located outside of application server 36 but accessible by application server 36 either through a direct link or through a network, such as network 12.

After receiving the user's initial reply in this example, engine 14 has collected four data elements. The first data element is that the user wants to make a transfer. The second data element is the amount the user wants to transfer ($500). The third and fourth data elements are the source and destination accounts, which the user stated in the request. Adaptive processing engines 14 can then use its adaptive processing ability to determine what other information it may need for the transaction.

In this example, engine 14 determines that it should collect an additional data element, the authentication of the user. In certain embodiments, this may also include the identification of the user or the identification of the user's accounts (if the user has more than one account). As one example, engine 14 may retrieve the user's account number by playing a voice prompt to the user asking for the account number. If it determines that it would be an appropriate text input response, engine 14 may ask the user to instead enter the account number by using the keypad on the user's phone. When the user replies with the account number, engine 14 may then make the transfer. In some embodiments, engine 14 may require additional information, such as a PIN or password associated with the account before making the transfer. Adaptive processing engines 14 can ask for this information as well, in a conversational manner. Adaptive processing engines 14 can ask the user for the required information in any particular order or combination. Adaptive processing engines 14 in this embodiment do not use a directed call flow to retrieve the information. Instead, engine 14 determines responses and queries on the fly, based on interaction with the user, and builds the proper input and output mechanisms for retrieving the information.

As another example, engine 14 may authenticate the user by voiceprint technology. When the user calls the system and responds to engine 14, engine 14 may contact a hardware or software module within engine 14 or accessible via network 12 to perform a voiceprint analysis and determine the identity of the speaker based at least in part on the user's voiceprint. Adaptive processing engines 14 could also authenticate the user by collecting a unique identifier from the user's device, such as the user's telephone number. In certain other embodiments, the user's device could have authentication hardware or software that is accessed by engine 14 during the course of the call and used to identify the owner of the device. The authentication software could be, for example, software that the user pre-installs and configures when an account at the bank is created. Adaptive processing engines 14 could access this authentication software stored on client 18 once the connection between client 18 and cell 14 has been created.

Once engine 14 has the required data elements, engine 14 can complete the transaction. In this example, engine 14 has the requested action (transfer), the amount ($500), the source and destination accounts (from savings to checking), and has authenticated the user (via account number and PIN or another method). Adaptive processing engines 14 can then contact application server 36 and instruct it to transfer the money from one account to the other. In some embodiments and for some types of transactions, it may be appropriate for engine 14 to send a response notifying the user that the transaction is complete.

In some cases, adaptive processing engines 14 may also send additional information, such as a transaction number. This can be presented to the user in a variety of ways, such as with voice or text. Adaptive processing engines 14 could also send a transaction receipt using email or another method to the user. Adaptive processing engines 14 may determine the most appropriate method for conveying this information to the user. In this embodiment, engine 14 could take a number of factors into account when determining the method to use, such as the input type (voice, text, etc.), the type of device (cell-phone, personal computer, etc.), the nature and size of the information, the user's predetermined preferences, and/or the requirements of the application server 36. For example, application server 36 may send an email receipt for certain transactions, or the user may request to be notified by mail of all transactions of a certain type performed on the user's accounts.

To perform certain transactions, engine 14 may query the user for more than one data element. For example, the user may respond to an initial greeting by engine 14 by stating, “I'd like to transfer some money.” In this case, engine 14 recognizes that this will be a transfer transaction, and then proceeds to acquire the additional data elements from the user to perform the transaction. Adaptive processing engines 14 can determine what information has been provided and what information is still needed from the user to complete the transaction. Adaptive processing engines 14 can retrieve the multiple data elements one at a time, or all at once, or in any suitable order or combination.

In some instances, engine 14 may ask for the amount to be transferred first. In other instances, engine 14 may ask for the account number(s) or for user authentication first. Adaptive processing engines 14 can retrieve this information from the user in a conversational manner, without relying on a directed call flow. Adaptive processing engines 14 can use an adaptive natural language process to retrieve the data elements until it can perform the transaction. During the querying of the user to retrieve the data elements, the user may desire to perform another or a different transaction, or attempt to cancel this transaction. Adaptive processing engines 14 is an adaptive engine, and can react to these changes or additional instructions and make the appropriate queries and/or take the appropriate actions to perform the actions requested by the user.

In certain embodiments, the user may interact with engine 14 by using text input instead of voice input. For example, a user may want to secure airline reservations using a data connection and a personal computer. The user may go to a website to set up reservations with a travel company that is utilizing system 10. Adaptive processing engines 14 utilize an adaptive natural language transaction process to collect information from the user to complete the transaction. Adaptive processing engines 14 do not use a directed call flow to collect the information, but instead adapts its responses and requests based on input provided by the user.

The user can connect to engine 14 through network 12. Data connection 32a may be used to couple the user's personal computer to network 12, which can connect to engine 14 through one or more other data connections 32 or directly. Adaptive processing engines 14 may greet the user, who could then type in a phrase or request to begin the interaction with engine 14. The user's initial request could be an unspecific request to make travel reservations. Adaptive processing engines 14 could begin the process of gathering the required data elements for completing one or more transactions by asking complex, undirected questions of the user and collecting information from those replies.

Adaptive processing engines 14 could collect the data elements one at a time or many at a time, and could also adapt its requests to the user's responses. Once it has the required data elements, engine 14 could complete the requested transaction. At that time, engine 14 could send feedback to the user, in the form of a confirmation screen that the user could print, an email to the user with the requested travel reservations, a reference number so that the user can access the reservation later, or any other form of feedback appropriate for the transaction. Adaptive processing engines 14 can also prepare for another transaction from the user, or even begin processing a transaction that the user requested while engine 14 was gathering data elements for the first transaction. Adaptive processing engines 14 can continue to adapt to the user's requests and answers until the user has completed all the desired transactions.

System 10 can also be used to provide information to one or more users that do not require an authenticated transaction. For example, a user may want to know the hours of the local branch of a bank. The user can call the bank's interactive voice response system using a telephone and connecting through a PSTN, for example. Adaptive processing engines 14 can work with the user to provide the requested information. In one example, the user may ask for the time that the bank closes today. Adaptive processing engines 14 can determine what type of information the user is asking for, and what, if any, additional information engine 14 needs to provide this information. If engine 14 needs more information from the user, engine 14 can provide complex queries to the user until it has all of the required data elements. Adaptive processing engines 14 may need to know, for example, which branch of the bank the user is referring to. Once the required data elements are collected by engine 14, the time can be presented to the user through any appropriate method, such as voice or text. The user may then complete the call or even request another transaction. For example, if the user needed directions to the facility, the engine 14—already aware of which facility—can obtain a map through the internet and deliver it to the user in an appropriate format: sending the graphic link of the map, reading the driving directions to the facility, etc.

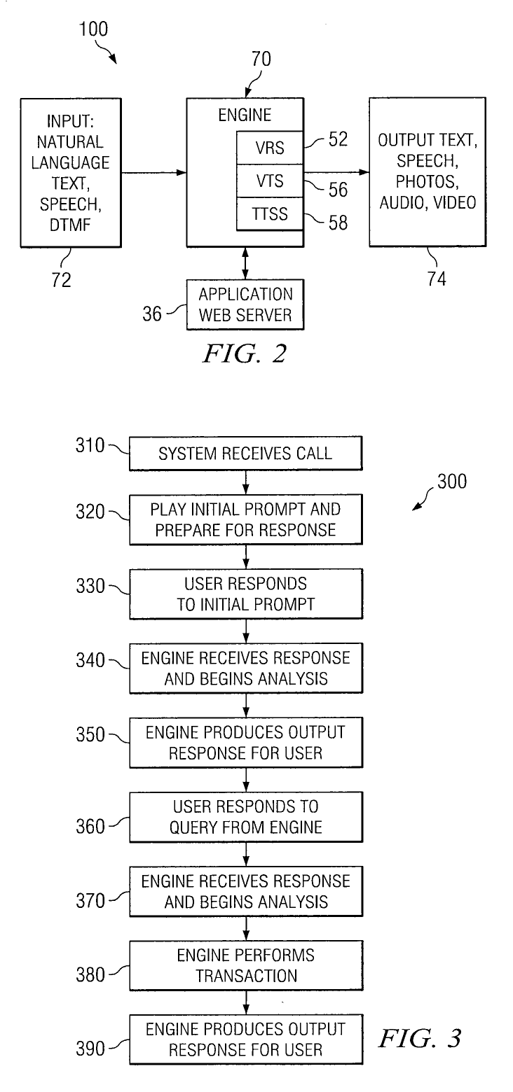

FIG. 2 illustrates one example of an adaptive natural language transaction processing system 100. System 100 comprises adaptive processing engine 70. Engine 70 may comprise any combination of hardware and/or software operable to perform natural language processing. In various embodiments, the structure and function of engine 70 can be substantially similar to the structure and function of engines 14 of FIG. 1. In this embodiment, engine 70 comprises an adaptive natural language transaction processing system along with other components for use in communicating with users of system 100. In certain embodiments, engine 70 may comprise one or more dictionaries, word lists, databases, and/or ontologies. One example of an ontology is WordNet. In this embodiment, engine 70 further comprises a voice recognition server 52, an application engine telephony server, such as VoiceXML, 56, and a text to speech server 58. These components may be situated in any combination of hardware or software and may reside in one location or in more than one location.

In this example, engine 70 is capable of receiving one or more inputs 72. Inputs 72 can comprise, for example, any type of input, such as text, speech, dual-tone multi-frequency (DTMF), keyboard, or stylus input. Engine 70 is further operable to communicate with one or more application servers 36. Application servers 36 are operable to receive instructions from engine 70 to perform transactions or send information to engine 70 or to one or more databases. Application servers 36 are also operable to receive information from engine 70 or one or more databases (not shown). Engine 70 is further operable to provide one or more natural language outputs 74 to one or more users. Engine 70 can, in certain embodiments, determine an optimal output type for communicating with a user. Outputs 74 can comprise any type of output, such as text, speech, audio (such as MP3), video (such as MP4), and/or images. Engine 70 can determine one or more output types based on the user's device, the type of output information, the quantity of output information, or on any other suitable factor.

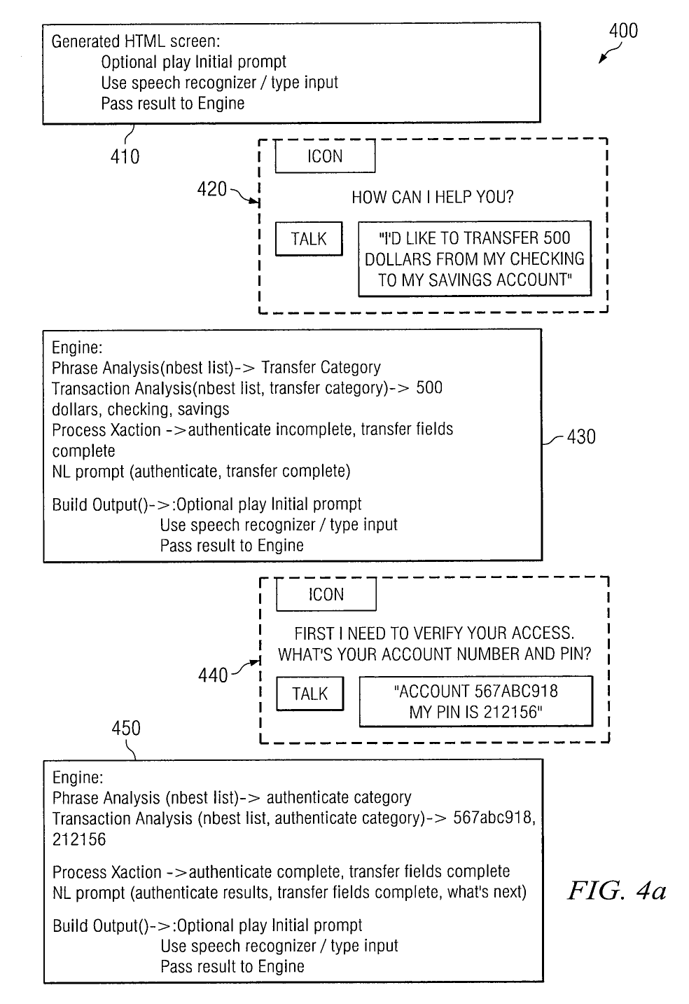

FIG. 3 is a flowchart illustrating one example method 300 of using adaptive natural language processing. In particular, the method may allow an adaptive natural language processing system to process one or more customer requests. In various embodiments, the adaptive natural language processing system can be substantially similar to systems 10 and 100 of FIGS. 1 and 2, respectively. The steps illustrated in FIG. 3 may be combined, modified, or deleted where appropriate. Additional steps may also be added to the example operation. Furthermore, the described steps may be performed in any suitable order.

Method 300 begins with step 310. The system receives a query from a user in step 310. The query can be received in any suitable manner, such as a call from a cell phone over a VOIP network or from a landline phone over a PSTN.

In step 320, an initial voice prompt may be played to the user. As one example, the voice prompt may say “Welcome. How may I help you?” VoiceXML or any other processing engine may be utilized by the system. Also in this step, the system may call to a speech recognizer to prepare for receiving the user's response to the initial prompt.

In step 330, the user may respond to the initial prompt. In some embodiments, system 10 can implement method 300, so it can receive the response and adapative processing engine 14 can respond in turn, adapting its response to the user based at least in part on information the user has provided. As one example, the user may state “I'd like to transfer $500 from my checking account, number 567def999, to my savings account.” Adaptive processing engines 14 can then begin analysis of the natural language response from the user. Adaptive processing engines 14 can adapt its next response based at least in part on the information it obtains from the user's response.

In step 340, engine 14 receives the user response and begins its analysis. A speech recognizer or other component may convert the user's spoken response to a machine-readable format, such as, for example, a textual representation. Adaptive processing engines 14 may begin by performing a Phrase Analysis, in which engine 14 can analyze the words spoken by the user to determine what request the user has. In this example, engine 14 can use natural language processing to determine that the user wishes to make a transfer. Adaptive processing engines 14 can then perform a Transaction Analysis, in which engine 14 can determine which bits of information have been provided by the user response and which bits of information engine 14 may still need to request from the user.

In this example, engine 14 can use its natural language processing capabilities to determine that the user has provided the amount of the transfer, the source account for the funds, and the destination account for the funds. Adaptive processing engines 14 can then determine what information, if any, is missing from completing the transaction and can produce an adaptive natural language query to prompt the user to provide the missing information. In this example, engine 14 determines that the user should be authenticated to complete the transaction.

In step 350 an output response is generated for the user. This output response can query the user for account authentication. Adaptive processing engines 14 may make calls to or use other components of system 10 to produce the output response. For example, an application telephony server 56 or text to speech server 58 may assist in producing the output response. Adaptive processing engine 14 is capable of producing a natural language response. The output response may be an audio response, and in this example could state “First I need to verify your access. What is your PIN?”

In step 360, the user responds to the query. In various embodiments, such as where system 10 implements method 300, system 10 can receive the response in natural language form and process the information contained in the response. The user may respond, for example, “My PIN is 343498.”

In step 370, engine 14 can perform a natural language analysis and determine that the user has supplied his PIN. Adaptive processing engines 14 can take that information and determine if the requested transaction can be completed, or whether additional information from the user is needed. In this example, engine 14 can perform the transaction after receiving the PIN. If engine 14 needed additional information to complete the user's request, engine 14 could query the user again, in any suitable manner, as many times as needed to retrieve the information.

In step 380, engine 14 can perform the transaction. Adaptive processing engines 14 may be operable to perform the transaction itself, or may instruct another component of system to perform the transaction. In this example, engine 14 can instruct an application server 36 to transfer the funds from the checking account to the savings account.

In step 390, engine 14 can produce an output response for the user. Adaptive processing engines 14 may notify the user that the transaction has been completed. Adaptive processing engines 14 could also ask the user if the there are any other additional transactions the user would like to complete. If so, engine 14 can receive the user's response and continue the adaptive natural language process to assist the user in one or more additional transactions. In some embodiments, engine 14 may store a record of the transaction, or may instruct another component of system 10 to store a record.

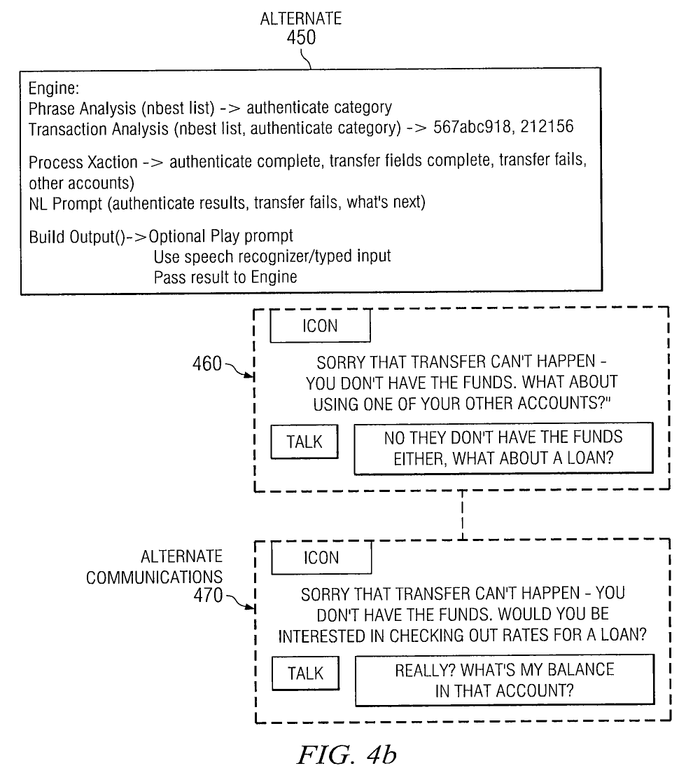

FIGS. 4a and 4b are flowcharts illustrating another example method 400 of using an adaptive natural language query. In particular, the method may allow an adaptive natural language processing system to process one or more customer requests. The steps illustrated in FIGS. 4a and 4B may be combined, modified, or deleted where appropriate. Additional steps may also be added to the example operation. Furthermore, the described steps may be performed in any suitable order. In various embodiments, the adaptive natural language processing system can be substantially similar to systems 10 and 100 of FIGS. 1 and 2, respectively.

FIG. 4a describes one example embodiment of an internet or cell phone data interaction between a user and system 10, while FIG. 4b illustrates an alternate step 450. In this example, a user may read or hear prompts from system 10 and speak responses into a microphone to interact with system 10 to conduct one or more transactions. The user may do this with any suitable web browser or Internet interface on any suitable hardware, such as a personal computer, a PDA, or a cellular phone. System 10 can provide adaptive natural language processing to the user's statements and queries and carry out the desired transaction for the user. System 10 can do this without relying on a directed call flow. Appropriate interaction with the user is generated through system 10 until the user has completed their desired transactions. Since no directed call flow is utilized, each user interaction can be different even when the same data transactions are performed. In general, the system 10 communicates with the user to determine the user's desired transaction(s); communication between the user, through system 10, continues until all desired transactions can be completed with information collected from the user. Through communication with data bases and other back end devices, system 10 is aware of what information it must collect from the user to complete the user's desired transaction(s). Components of System 10 allow it to communicate with the user in a way that the user can respond effectively.

Method 400 begins with step 410. An HTML screen may be generated that provides an audio or text initial prompt to the user. System 10 may also utilize a speech recognizer or any other component of system 10, such as engine 14, to receive the input from the user. Once input is received, it may be formatted or repackaged into a suitable format and passed to engine 14 for processing. Adaptive processing engines 14 or any suitable component of system 10 may process the user input.

Step 420 illustrates an example initial prompt from system 10 to a user. The prompt may be accompanied by a company icon as shown. In this example, system 10 asks the user “How can I help you?” The user can respond by speaking, such as “I'd like to transfer 500 dollars from my checking to my savings account.” System 10 receives this response and can begin processing.

Step 430 illustrates some of the processing steps system 10 and/or engine 14 may undergo to process the user request. In certain embodiments, engine 14 may first perform a Phrase Analysis to determine what the user is requesting. In this example, engine 14 determines that the user wants to make a transfer of money between two accounts. Adaptive processing engines 14 may then perform a Transaction Analysis, in which engine 14 determines which data elements of the transfer transaction have been received, and which elements may be needed from the user. In some embodiments, a transfer may require data elements corresponding to a transfer amount, a source account, a destination account, and authentication. Application server 36 or another component of system 10 may be used to determine which data elements are needed to complete the transaction. In this example, the user has provided the transfer amount, the source account, and the destination account. Adaptive processing engines 14 may determine that authentication is incomplete, and engine 14 can then produce an adaptive natural language query to ask the user for authentication. Adaptive processing engines 14 can do this in a variety of ways, and can use a method that is appropriate for the circumstances of the transaction. In most cases, adaptive processing engines 14 can determine the language to utilize and structure of a graphical, verbal or text query. In this example, engine 14 may determine that a text query asking the user for an account number and PIN is appropriate. System 10 can prepare the output response to the user and also prepare to receive the user's next response.

In step 440, system 10 responds to the user's initial query with a request for more information. For example, system 10 may respond “First, I need to verify your access. What's your account number and pin?” The user can read this and then, if he or she chooses, can respond verbally into a microphone with “Account 567abc918 and PIN 212156.” System 10 receives this response and can then continue processing.

In step 450, system 10 may perform more processing steps. Adaptive processing engines 14 may perform a Phrase Analysis and determine that the user is providing authentication information. Adaptive processing engines 14 can then analyze the information provided by the user in order to authenticate the account. In this example, the user provided an account number and PIN. The account number and PIN can be compared to information stored in one or more databases to verify the user. Once the account number and pin are verified, the user has provided enough elements to perform the transfer. Adaptive processing engines 14 or another component of system 10 can perform the transaction. Once complete, other processing steps may be taken and/or engine 14 can provide a natural language prompt asking the user if there will be any other transactions. System 10 can also prepare to receive those responses. The process described above can begin again if the user has further requests. In addition, for example, if the user does not have sufficient funds to transfer, adaptive processing engines 14 or another component of system 10 can communicate the problem and offer possible solutions to the user in step 460—thus possibly fulfilling multiple transactions where only one was initially requested. For example, those possible solutions may involve advertising loans step 470—thus taking the user review loan rates or communicating other account balances for possible funds transfer. Through its components, System 10 is capable of determining possible offerings and communicating those offerings to the user in any applicable format.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An adaptive processing system, comprising:
one or more communication devices adapted to communicate one or more requests for processing, wherein each of the one or more requests comprises information from a user;
one or more adaptive processing engines adapted to receive the one or more requests, the one or more adaptive processing engines adapted to parse the one or more requests and to communicate one or more queries to the one or more communication devices based at least in part on the information of the request, wherein the parsing of the one or more queries comprises analyzing the information from the user, determining one or more next steps to perform based at least in part on the information from the user, and generating one or more queries for additional information; and
an application server adapted to communicate with the one or more adaptive processing engines in response to the one or more requests based at least in part on the information of the one or more requests.

2. The system of claim 1, wherein the each of the one or more communication devices is operable to communicate a response to the one or more queries for information from the one or more adaptive processing engines for the additional information.

3. The system of claim 2, wherein the response to the one or more queries is selected from the group consisting of a voice input, a DTMF input, a stylus input, and a keyboard input.

4. The system of claim 1, wherein the one or more queries to the one or more communication devices is selected from the group consisting of an audio output, a voice output, a text output, a video output, file output, and an image output.

5. The system of claim 1, wherein the adaptive processing engine operates to process the one or more requests substantially free from using a directed call flow.

6. The system of claim 1, wherein the request for processing comprises a natural language input.

7. The system of claim 1, wherein each of the one or more queries for additional information is based at least in part on specific data contained within the one or more requests received from the one or more communication devices.

8. The system of claim 1, further comprising a speech recognizer operable to convert speech from one or more communication devices into a form usable by a natural language engine.

9. An adaptive natural language system, comprising:
an adaptive natural language processing engine adapted to adjust its processing based at least in part on one or more data elements received from a communication device and to generate one or more queries for one or more additional data elements;
a voice recognition server operable to interpret inputs received from a user of the communication device;
a telephony server operable to provide an interface between one or more components and one or more users; and
a text to speech server operable to convert information in text format to audio speech.

10. The system of claim 9, wherein the natural language processing engine operates to process the one or more data elements from the communication device substantially free from using a directed call flow.

11. The system of claim 9, further comprising an application server operable to process transactions based at least in part on the one or more data elements from the communication device.

12. A method for processing a transaction, comprising:
receiving one or more requests for processing at an adaptive processing engine, each of the one or more requests comprises one or more data elements from a user;
analyzing the one or more data elements from the user;
determining one or more next steps to perform based at least in part on the one or more data elements from the user;
generating one or more queries for additional information based at least in part on the one or more data elements of the request;
communicating the one or more queries for additional information.

13. The method of claim 12, the method further comprising communicating one or more pieces of information to one or more application servers based at least in part on the one or more data elements.

14. The method of claim 13, the method further comprising communicating one or more pieces of information from the one or more application servers to the one or more communication devices.

15. The method of claim 12, wherein the step of generating the one or more queries for additional information is substantially free from using a directed call flow.

16. The method of claim 12, wherein the one or more requests for processing are selected from the group consisting of a voice input, a DTMF input, a stylus input, and a keyboard input.

17. The method of claim 12, wherein the one or more queries for additional information are selected from the group consisting of an audio output, a voice output, a text output, a video output, and an image output.

18. The method of claim 12, further comprising communicating a response to the one or more queries for additional information.

19. The method of claim 12, wherein the one or more requests for processing comprise a natural language input.

20. The method of claim 12, wherein each of the one or more queries for additional information is based at least in part on specific data contained within the one or more requests received from the one or more communication devices.
